(19) United States
(12) Patent Application Publication
(10) Pub. No.: US 2025/0239646 A1
(43) Pub. Date: Jul. 24, 2025

(54) FLEXIBLE AND LIQUID-FREE SOLID POLYMER ELECTROLYTE, METHODS FOR FABRICATING THE SAME AND ITS APPLICATION THEREOF

(71) Applicant: Nano and Advanced Materials Institute Limited, Hong Kong (HK)

(72) Inventors: Yu Tat TSE, Hong Kong (HK); XinYing SUN, Hong Kong (HK); Shengbo LU, Hong Kong (HK); Chenmin LIU, Hong Kong (HK)

(21) Appl. No.: 19/017,826

(22) Filed: Jan. 13, 2025

Related U.S. Application Data
(60) Provisional application No. 63/622,085, filed on Jan. 18, 2024.

(51) Int. Cl. H01M 10/056; H01M 10/0525; H01M 10/42

(52) U.S. Cl. CPC H01M 10/056; H01M 10/0525; H01M 10/4235; H01M 2300/0071; H01M 2300/0082; H01M 2300/0091

(57) ABSTRACT

The present invention provides a flexible and liquid-free solid polymer electrolyte comprising a solid polymer matrix with a dielectric coefficient of at least 30 at room temperature and 100 Hz, at least one lithium salt, and active ceramic particles capable of conducting lithium ions. The solid polymer matrix promotes lithium salt dissociation, achieving an ionic conductivity greater than 1 mS/cm at room temperature and a mechanical strength of at least 1 MPa. The invention further includes a method for fabricating the solid polymer electrolyte using a facile solution casting and vacuum drying process. Additionally, the invention relates to a non-flammable and impact-resistant lithium-ion battery incorporating the solid polymer electrolyte, demonstrating stable operation under challenging environmental conditions and physical stress. The resulting lithium-ion batteries exhibit enhanced safety, mechanical robustness, and performance, making them suitable for applications in high-energy storage systems, flexible electronics, and electric vehicles.

### CROSS-REFERENCE TO RELEVANT APPLICATION

The present application claims priority from a U.S. provisional patent application Ser. No. 63/622,085 filed on 18 Jan. 2024, and the disclosures of which are incorporated by reference in their entireties.

### TECHNICAL FIELD

The present invention generally relates to the fields of materials science and electrochemistry, particularly flexible and liquid-free solid polymer electrolytes, and their applications in lithium-ion batteries.

### BACKGROUND

As the demand for portable electronic devices, wearable technologies, and electric vehicles continues to grow rapidly, there is an increasing need for high-performance, safe, and reliable lithium-ion batteries. Conventional lithium-ion batteries primarily utilize lithium hexafluorophosphate (LiPF₆) dissolved in aprotic organic solvents as the electrolyte. While these liquid electrolytes provide high ionic conductivity, they suffer from several inherent limitations, such as volatility, flammability, and poor thermal stability, which pose significant safety risks, particularly under extreme environmental or operating conditions.

Solid polymer electrolytes (SPEs) have emerged as a promising alternative to liquid electrolytes due to their non-flammable and thermally stable nature. However, current SPE technologies, such as polyethylene oxide (PEO)-based or polyvinylidene fluoride (PVDF)-based systems, face critical limitations. These include low ionic conductivity at room temperature due to the high crystallinity of the polymer matrix, which impedes the segmental motion of polymer chains and reduces lithium-ion transport efficiency. Furthermore, increasing the concentration of lithium salt in such systems often fails to enhance ionic conductivity because the low dielectric constant of the polymer matrix does not adequately promote the dissociation of lithium salts into free lithium ions. In addition, the mechanical strength of conventional SPEs is insufficient, limiting their applicability in large-scale battery fabrication and integration processes.

Therefore, there is an urgent demand for the development of advanced SPEs with enhanced ionic conductivity, improved thermal stability, and superior mechanical strength to address the limitations of conventional SPE systems.

### SUMMARY OF THE INVENTION

In order to overcome the low ionic conductivity and mechanical strength issues, the present invention seeks to pioneer advancements in the development of a flexible and liquid-free solid polymer electrolyte. One aspect of the present invention provides a flexible and liquid-free solid polymer electrolyte, which includes a solid polymer matrix formed from a mixture of crystalline and non-crystalline polymers. The mixture has a dielectric coefficient of at least 30 at room temperature and 100 Hz; at least one lithium salt; and one or more active ceramic particles capable of conducting lithium ions. The solid polymer matrix promotes dissociation of the at least one lithium salt to free lithium ions, the flexible and liquid-free solid polymer electrolyte has an ionic conductivity of greater than 1 mS/cm at room temperature, and a mechanical strength of at least 1 MPa.

In an embodiment, the mixture of crystalline and non-crystalline polymers is selected from the group consisting of: P(VDF-CTFE), P(VDF-CDFE), P(VDF-CFE), P(VDF-HFP), P(VDF-CDFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE).

Preferably, the mixture of crystalline and non-crystalline polymers is P(VDF-TrFE-CTFE) with a formula of:

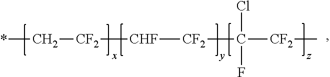

wherein x=60 to 70, y=25 to 35, and z=3 to 8.

The solid polymer matrix comprises 60% to 70% of VDF, 25% to 35% of TrFE and 3% to 8% of CTFE.

In an embodiment, the solid polymer matrix has a molecular weight of 40,000 to 600,000 g/mol.

In an embodiment, the at least one lithium salt includes lithium bis(trifluoromethanesulfonyl)imide, lithium bis(fluorosulfonyl)imide, lithium perchlorate, lithium hexafluorophosphate, lithium triflate, lithium tetrafluoroborate, lithium hexafluoroarsenate, lithium bis(oxalato)-borate, lithium difluoro(oxalato)borate, or a combination thereof.

In an embodiment, the one or more active ceramic particles have a formula of Li₁₊ₓAlₓTi₂₋ₓ(PO₄)₃ (LATP), x=0.2 to 0.4. The addition of LATP ceramic particles further boosts the ionic conductivity and mechanical strength.

Optionally, the active ceramic particles can also have another formula of Li₇La₃Zr₂O₁₂, Li₁₀GeP₂S₁₂, or Li₅La₃Ta₂O₁₂.

Another aspect of the present invention provides a facile tape-casting method for fabricating the flexible and liquid-free solid polymer electrolyte. The method includes mixing the solid polymer matrix and the at least one lithium salt in an organic solvent to obtain a first homogenous solution; adding the one or more active ceramic particles into the first homogenous solution, and mixing uniformly to obtain a second homogenous solution; casting the second homogenous solution on a substrate; and vacuum drying the cast substrate to obtain the flexible and liquid-free solid polymer electrolyte.

In an embodiment, the mass ratio of the solid polymer to the at least one lithium salt is 3:1 to 3:5.

In another embodiment, the mass ratio of the solid polymer to the active ceramic particles is 10:0.5 to 10:4.

In an embodiment, the mass ratio of the solid polymer to the organic solvent is 5:95 to 15:85.

In an embodiment, the organic solvent includes N,N-dimethylformamide, acetonitrile, dimethylsulfoxide, N-methylpyrrolidone, or tetrahydrofuran.

In an embodiment, the vacuum drying temperature is 40-90° C. for 6-48 hours.

In one embodiment, the wet thickness of polymer-ceramic-salt solution is in a range of 200 μm to 800 μm.

Another aspect of the present invention provides a non-flammable and impactable lithium-ion battery, which includes at least one negative electrode with one or more first layers, at least one positive electrode with one or more second layers and a flexible and liquid-free solid polymer electrolyte of claim 1 to isolate the at least one negative electrode and the at least one positive electrode. The non-flammable and impactable lithium-ion battery is able to run for at least 20 cycles while maintaining a capacity of at least 80% or more.

In an embodiment, the non-flammable and impactable lithium-ion battery is designed to a lithium-ion pouch cell, a coin cell, a stacking pouch cell, a wearable pouch cell, or a winding-type cell.

In an embodiment, the one or more first layers include graphite, lithium metal, carbon black, carbon nanotubes and/or graphene, or a combination thereof.

In an embodiment, the one or more second layers include lithium manganese oxide, lithium cobalt oxide and/or lithium iron phosphate, or a combination thereof.

In an embodiment, the non-flammable and impactable lithium-ion battery is capable of operating normally under challenging environmental conditions.

In an embodiment, the non-flammable and impactable lithium-ion battery further includes a package material. The package material includes an aluminum laminate of polyethylene terephthalate (PET), polyamide (PA) or cast polypropylene (CPP).

### BRIEF DESCRIPTION OF THE DRAWINGS

Embodiments of the invention are described in more details hereinafter with reference to the drawings, in which:

FIG. 1 illustrates a schematic diagram of the interaction between the solid polymer matrix and lithium salt. The polymer matrices are PVDF and P(VDF-TrFE-CTFE) respectively;

FIG. 2A illustrates the dielectric constants of PVDF and P(VDF-TrFE-CTFE) without adding active ceramic particles;

FIG. 2B illustrates the ionic conductivity of PVDF and P(VDF-TrFE-CTFE) without addition of active ceramic particles;

FIG. 3 illustrates the Raman spectrum of the two solid polymer electrolytes;

FIG. 4A illustrates the fabrication method of the flexible and liquid-free solid polymer electrolyte by solution casting method;

FIG. 4B illustrates a scanning electron microscope (SEM) image of the flexible and liquid-free solid polymer electrolyte according to one embodiment of the present invention;

FIG. 5A illustrates the design of a non-flammable and impactable lithium-ion battery according to one embodiment of the present invention;

FIG. 5B illustrates the design of a winding type battery and its capacity;

FIG. 6A illustrates a pouch cell containing the flexible and liquid-free solid polymer electrolyte under hammer impact conditions;

FIG. 6B illustrates the pouch cell containing the flexible and liquid-free solid polymer electrolyte under shear conditions;

FIG. 7A illustrates the ionic conductivities of the flexible and liquid-free solid polymer electrolyte with varying contents of active ceramic particles according to one embodiment of the present invention;

FIG. 7B illustrates the tensile strength of the flexible and liquid-free solid polymer electrolyte according to one embodiment of the present invention;

FIG. 7C illustrates the 3C compression modulus of the flexible and liquid-free solid polymer electrolyte according to one embodiment of the present invention; and

FIG. 8 illustrates thermogravimetric analysis (TGA) data of the flexible and liquid-free solid polymer electrolyte according to one embodiment of the present invention.

### DETAILED DESCRIPTION

In the following description, flexible and liquid-free solid polymer electrolytes, are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

To meet the growing needs of portable electronics, wearable technologies, and electric vehicles, next-generation SPEs should incorporate innovative polymer blends or composites that facilitate better ion transport, increase the dissociation of lithium salts, and ensure long-term safety and reliability under various operating conditions. Accordingly, the present invention provides a novel flexible and liquid-free solid polymer electrolyte that combines high ionic conductivity, excellent mechanical strength, and thermal stability. By incorporating a solid polymer matrix with a high dielectric constant and active ceramic particles capable of conducting lithium ions, this innovative SPE enables effective lithium salt dissociation and ion transport while maintaining mechanical robustness and flexibility. This advancement represents a significant improvement over existing technologies and paves the way for safer and more efficient lithium-ion batteries for various applications, including high-energy-density storage systems, flexible electronics, and electric vehicles.

In one embodiment, the solid polymer matrix is a mixture of crystalline and non-crystalline polymers, which have a dielectric coefficient much higher than PVDF (approximately 8 to 12). Higher dielectric coefficient promotes the dissociation of lithium salts, and providing a solid, flexible structure that remains liquid-free.

For instance, PVDF-TrFE-CTFE has a dielectric coefficient of at least 30 at room temperature and 100 Hz. For instance, the dielectric coefficient can be higher than 40, 50, 60, or 70.

In one embodiment, the solid polymer matrix may include different solid polymer matrixes as listed in Table 1, or their combination thereof, or other solid polymer matrixes having a molecular weight of 40,000 to 600,000 g/mol

TABLE 1

| Full name | Abbreviation |
|---|---|
| Vinylidenedifluoroethylene | VDF |
| Hexafluoropropylene | HFP |
| Vinylidenedifluoroethylene | VDF |
| Chlorotrifluoroethylene | CTFE |
| Chlorofluoroethylene | CFE |
| Chlorodifluoroethylene | CDFE |
| Trifluoroethylene | TrFE |
| Tetrafluoroethylene | TFE |

The mixture of crystalline and non-crystalline polymers can be selected from various combinations of polymers such as P(VDF-CTFE), P(VDF-CDFE), P(VDF-CFE), P(VDF-HFP), P(VDF-CDFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE). These copolymers incorporate various fluorinated monomers that adjust the crystalline and amorphous regions of the polymer matrix, thereby controlling the dielectric properties and mechanical flexibility of the electrolyte.

PVDF itself is a semi-crystalline polymer, meaning it has both crystalline and amorphous regions in its structure. The crystalline structure of PVDF contributes to its high mechanical strength and dielectric properties. Copolymers of PVDF with monomers that have a regular or highly ordered structure, such as CTFE and CDFE, tend to maintain or increase the crystalline regions. These monomers allow for better alignment of the polymer chains, promoting crystallinity. The co-polymers P(VDF-CTFE), P(VDF-CDFE), P(VDF-TrFE-CFE), P(VDF-TFE-CTFE), P(VDF-TFE-CFE) often retain a significant degree of crystallinity, depending on the ratio of PVDF to the other monomer. CTFE, CDFE, and TFE tend to support crystalline regions.

Among these copolymers, P(VDF-TrFE-CTFE) is one preferred embodiment, where the polymer composition comprises varying amounts of VDF, TrFE and CTFE. The P(VDF-TrFE-CTFE) has a formula of:

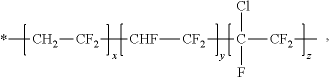

where x=60 to 70, y=25 to 35, and z=3 to 8.

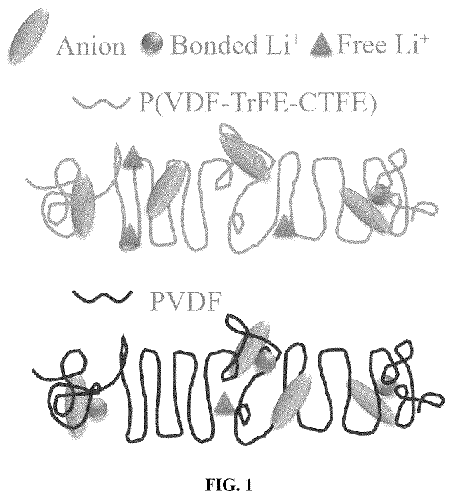

In P(VDF-TrFE-CTFE), the VDF content ranges from 60% to 70%, TrFE from 25% to 35%, and CTFE from 3% to 8%. Referring to FIG. 1, it illustratively demonstrates that more dissociated Li ions are available for ion conduction in higher dielectric polymer P(VDF-TrFE-CTFE).

In other embodiments, in P(VDF-CTFE), the VDF content ranges from 50% to 90%, and CTFE from 10% to 50%. In P(VDF-CDFE), the VDF content ranges from 50% to 90%, and CDFE from 10% to 50%. In P(VDF-CFE), the VDF content ranges from 50% to 90%, and CFE from 10% to 50%. In P(VDF-HFP), the VDF content ranges from 50% to 90%, and HFP from 10% to 50%. In P(VDF-TrFE-CFE), the VDF content ranges from 60% to 70%, TrFE from 25% to 35%, and CFE from 3% to 8%. In P(VDF-TrFE-HFP), the VDF content ranges from 60% to 70%, TrFE from 25% to 35%, and HFP from 3% to 8%. In P(VDF-TrFE-CDFE), the VDF content ranges from 60% to 70%, TrFE from 25% to 35%, and CDFE from 3% to 8%. In P(VDF-TFE-CTFE), the VDF content ranges from 60% to 70%, TFE from 25% to 35%, and CTEF from 3% to 8%. In P(VDF-TFE-CFE), the VDF content ranges from 60% to 70%, TFE from 25% to 35%, and CFE from 3% to 8%. In P(VDF-TFE-HFP), the VDF content ranges from 60% to 70%, TFE from 25% to 35%, and HFP from 3% to 8%. In P(VDF-TFE-CDFE), the VDF content ranges from 60% to 70%, TFE from 25% to 35%, and CDFE from 3% to 8%.

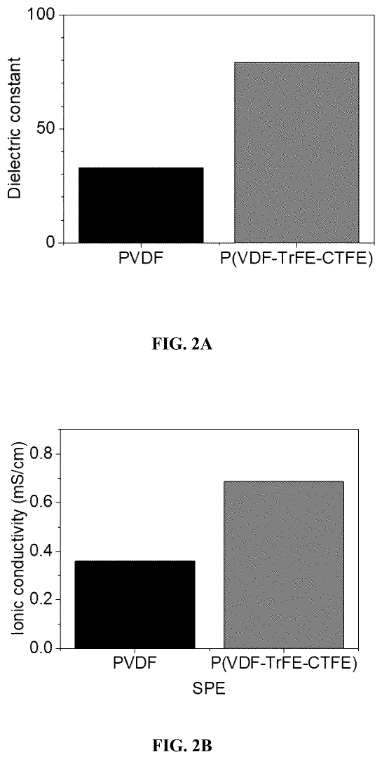

As shown in FIG. 2A, the dielectric constant of PVDF-TrFE-CTFE is approximately 80 at room temperature and 100 Hz, which is significantly higher compared to that of PVDF, which has a dielectric constant of around 30. This enhanced dielectric property of PVDF-TrFE-CTFE makes it more suitable for applications requiring high dielectric performance, such as capacitors and sensors, due to its ability to store more electrical energy at the same voltage.

The at least one lithium salt used in the present invention may include, but are not limited to, lithium bis(trifluoromethanesulfonyl)imide, lithium Bis(fluorosulfonyl)imide, lithium perchlorate, lithium hexafluorophosphate, lithium triflate, lithium tetrafluoroborate, lithium hexafluoroarsenate, lithium bis(oxalato)-borate, lithium difluoro(oxalato)borate, or a combination thereof. These salts provide the necessary free lithium ions for electrochemical reactions, enhancing the electrolyte's ionic conductivity.

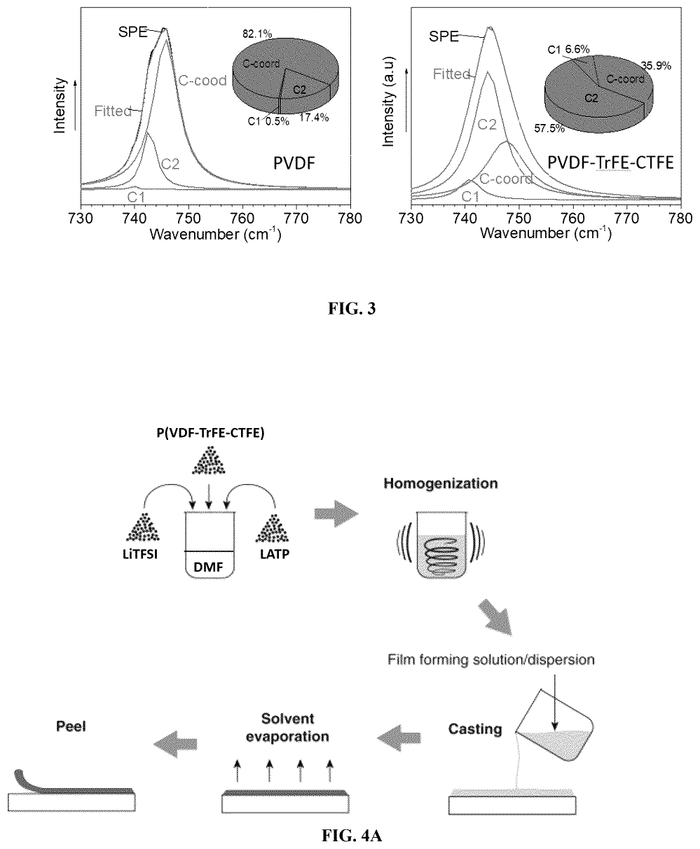

The solid polymer matrix promotes the dissociation of at least one lithium salt to free lithium ions. More than 60% of lithium salt can be dissociated in the solid polymer electrolyte, as measured by Raman spectroscopy (FIG. 3).

Referring to FIG. 2B, it can be observed that the ionic conductivity of high dielectric PVDF-TrFE-CTFE SPE is higher than that of the low dielectric PVDF SPE. This is attributed to the greater quantity of dissociated Li ions.

To further enhance the ionic conductivity of the electrolyte, the solid polymer matrix includes one or more active ceramic particles. The active ceramic particles have a formula of Li₁₊ₓAlₓTi₂₋ₓ(PO₄)₃, x=0.2 to 0.4. The active ceramic particles can conduct the lithium ions. With the addition of ceramic particles to the SPE, thermal stability, mechanical strength as well as ionic conductivity are further enhanced.

In one embodiment, the ceramic particles have a size distribution of 0.1 μm to 10 μm.

In one embodiment, the flexible and liquid-free solid polymer electrolyte exhibits an ionic conductivity of greater than 1 mS/cm at room temperature, and a mechanical strength of at least 1 MPa. Such high performance is achieved through the careful optimization of the polymer matrix, where the selection of suitable monomers and copolymers, combined with precise crosslinking and filler incorporation, enhances both structural integrity and ionic mobility. The polymer network is engineered to maintain flexibility, while the ionic conductivity is boosted by the introduction of ionic conductive sites and the reduction of crystallinity. These advancements ensure both mechanical robustness and efficient ion transport, essential for the electrolyte's performance in practical applications.

Turning to FIG. 3, at the same polymer/Li salt ratio, the PVDF-TrFE-CTFE solid polymer electrolyte possesses a higher percentage of dissociated form of Li salt (C1 and C2) and lower percentage of the undissociated form of Li salt (C-coord), as measured by Raman spectroscopy.

In other embodiment, the flexible and liquid-free solid polymer electrolyte, PVDF SPE (no LATP), exhibits an ionic conductivity of 0.36 mS/cm at room temperature.

In other embodiment, the flexible and liquid-free solid polymer electrolyte, PVDF-TrFE-CTFE (no LATP), exhibits an ionic conductivity of 0.69 mS/cm at room temperature.

In another aspect, the present invention also provides a method for fabricating the flexible and liquid-free solid polymer electrolyte. The method includes:
(1) Mixing the solid polymer matrix and lithium salt: the solid polymer matrix and at least one lithium salt are mixed in an organic solvent to form a first homogenous solution. The solvent dissolves the polymers and lithium salts, allowing for uniform distribution of the components;
(2) Adding active ceramic particles: The active ceramic particles are added to the first homogenous solution, and the mixture is stirred or processed to ensure that the ceramic particles are evenly distributed throughout the solution, forming a second homogenous solution;
(3) Casting and drying: the second homogenous solution is then cast onto a substrate, such as a glass or metal surface, to form a thin film. The cast film is then subjected to vacuum drying at a temperature range of 40-90° C. for 6-48 hours to remove any remaining solvent, leaving behind the solid polymer electrolyte.

The mass ratio of the solid polymer to the at least one lithium salt is 3:1 to 3:5. The mass ratio of the solid polymer to the active ceramic particles is 10:0.5 to 10:4. The mass ratio of the solid polymer to the organic solvent is 5:95 to 15:85. Suitable organic solvents may be N,N-dimethylformamide, acetonitrile, dimethylsulfoxide, N-methylpyrrolidone, or tetrahydrofuran.

In another aspect, the flexible and liquid-free solid polymer electrolyte can be incorporated into a variety of lithium-ion battery designs. The electrolyte isolates the negative electrode and positive electrode, preventing short circuits while enabling efficient ion transfer between the electrodes. The electrolyte ensures that the lithium-ion battery remains non-flammable, impact-resistant, and capable of running for at least 20 cycles while maintaining a capacity of at least 80%.

The battery may be designed in various cell types, including lithium ion pouch cells, coin cells, stacking pouch cells, wearable pouch cells, or winding-type cells, and is capable of operating under challenging environmental conditions.

The at least one negative electrode has one or more first layers, and the at least one positive electrode has one or more second layers. The first layers may be made from graphite, lithium metal, carbon black, carbon nanotubes and/or graphene, or a combination thereof. The second layers may be made from lithium manganese oxide, lithium cobalt oxide and/or lithium iron phosphate, or a combination thereof.

In another embodiment, the non-flammable and impactable lithium-ion battery further comprises a package material to provide structural integrity and additional safety, including aluminum laminate of PET, PA or CPP.

The liquid-free solid polymer electrolyte has a compression modulus greater than 0.8 GPa at 100 Hz and high flexibility, allowing the membrane to be rolled for use in winding-type lithium batteries.

The mechanical robustness of solid polymer electrolyte also renders high safety to the cells, enabling normal operation even under abuse. For instance, the non-flammable and impactable lithium-ion battery with the present solid polymer electrolyte can be operated normally under challenging environmental conditions, such as high-temperature environments, high-humidity environments, mechanical impact, etc.

### EXAMPLES

### Example 1

### Preparation of a Flexible and Liquid-Free Solid Polymer Electrolyte

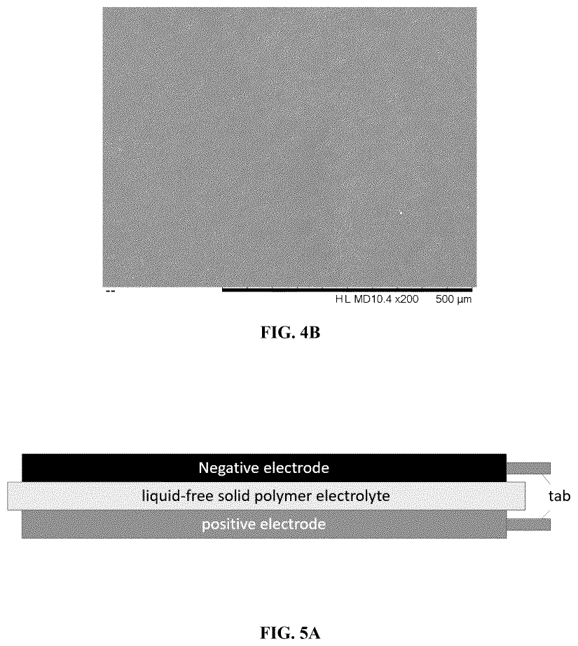

Turning to FIG. 4A, the necessary materials including Lithium bis(trifluoromethanesulfonyl)imide (LiTFSI), P(VDF-TrFE-CTFE) (polyvinylidene fluoride-trifluoroethylene-chlorotrifluoroethylene copolymer), and LATP (lithium ceramic) are prepared first. First, the P(VDF-TrFE-CTFE) copolymer is dissolved in an organic solvent (e.g., dimethylformamide, DMF) to form a homogeneous solution, which was stirred at 60-80° C. for 6-24 hours. LiTFSI is then added to the solution in a mass ratio of 33-133 wt % with respect to the copolymer, and stirred for an additional 6 hours. LATP ceramic particles are incorporated into the solution at a mass ratio of 5-25 wt % with respect to copolymer, followed by stirring for 12 hours for uniform dispersion.

The resulting solution is cast onto a glass substrate to create a uniform film. Finally, the solvent evaporation in a well-ventilated area is conducted, and the casting solution is transformed into the solid polymer electrolyte. The resulting flexible and liquid-free solid polymer electrolyte is then peeled from the substrate, trimmed to obtain uniform thickness, and characterized.

The prepared solid polymer electrolyte exhibited a smooth surface (FIG. 4B), mechanical integrity, and a thickness of approximately 30-80 m.

### Example 2

### Fabrication of a Winding-Type Battery Using the Solid Polymer Electrolyte

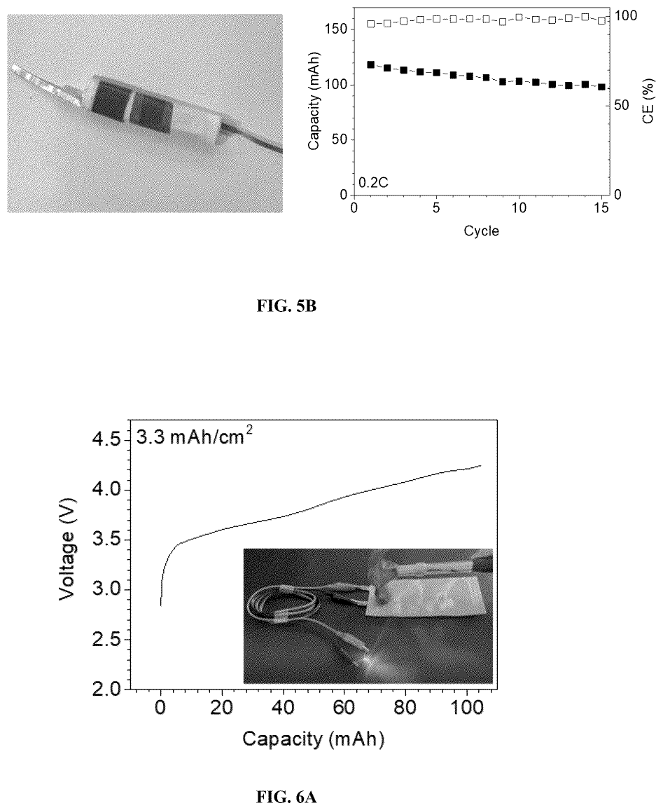

The present invention provides a non-flammable and impactable lithium-ion battery, it includes at least one negative electrode with one or more first layers; at least one positive electrode with one or more second layers; and a flexible and liquid-free solid polymer electrolyte to isolate the at least one negative electrode and the at least one positive electrode (FIG. 5A).

More specifically, in this example, a winding-type lithium-ion battery is fabricated utilizing the flexible and liquid-free solid polymer electrolyte prepared in Example 1. The prepared SPE is highly flexible that it can be rolled to a winding-type battery.

A negative electrode, two pieces of prepared SPE and a positive electrode are stacked and well-aligned in the following order (from bottom to top): prepared SPE, negative electrode, prepared SPE and positive electrode. the layers are carefully aligned before being rolled into a cylindrical shape to form the battery. Then, the stack is rolled tightly into a winding-type battery and electrode displacement should be avoided. The winding-type battery can cycle normally (FIG. 5B).

The winding-type battery is encapsulated in an aluminum laminate package, and the edges were sealed using a heat-sealing process to prevent moisture or air infiltration. The battery is then mildly compressed to ensure uniform pressure distribution and stabilized for 24 hours before testing. The battery demonstrated excellent mechanical flexibility, structural stability, and effective ion conduction, maintaining >80% capacity after 20 charge-discharge cycles at room temperature. The battery was also resistant to hammer impact, as verified through LED illumination tests, and operated normally at temperatures ranging from −20° C. to 60° C.

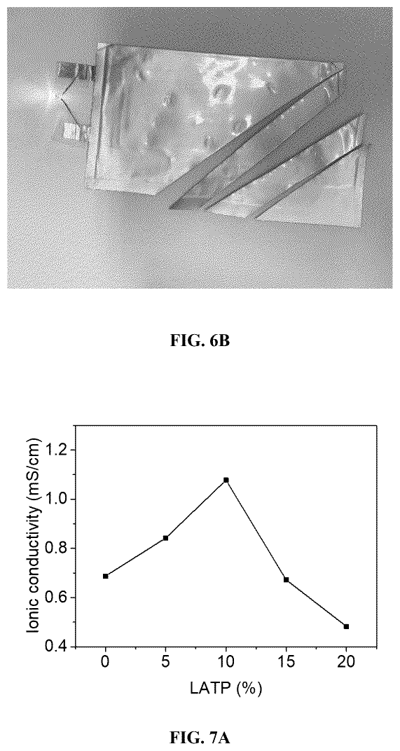

Additionally, the prepared SPE can also be applied to a pouch cell, as shown in FIGS. 6A-6B. The pouch cell operated normally under hammer impact. It is because of the high storage modulus of the SPE at high frequency. Furthermore, the pouch cell tested in FIG. 6A underwent physical abuse, including cutting (FIG. 6B). The LED bulb illuminated when a fully charged LIB is cut into pieces. These results confirm that the pouch cell continued to operate normally even under physical abuse.

### Example 3

### Influence of Ceramic Content on Ionic Conductivity and Mechanical Strength

This example investigates the effect of varying LATP ceramic particle content on the ionic conductivity and mechanical properties of the solid polymer electrolyte. Solid polymer electrolyte films are prepared with LATP contents of 5%, 10%, 15%, and 20% by mass relative to the solid polymer, following the preparation method outlined in Example 1.

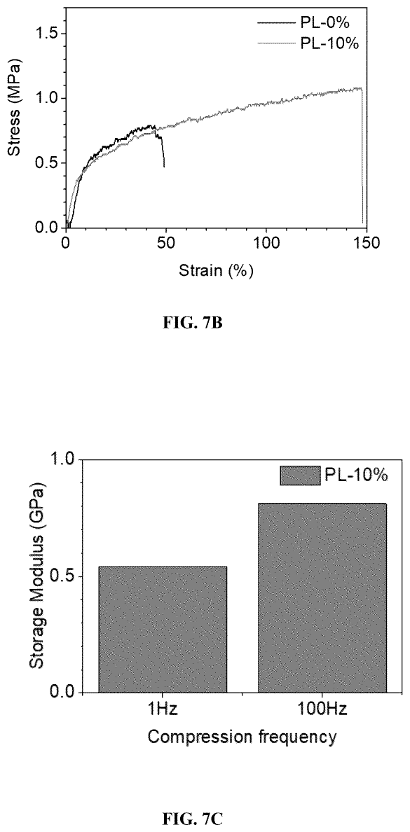

Referring to FIGS. 7A-7B, the active ceramic particles LATP are uniformly dispersed in the PVDF-TrFE-CTFE SPE. When the content of LATP reaches 10%, the ionic conductivity and tensile strength increase to greater than 1 mS/cm and greater than 1 MPa, respectively. FIG. 7C also demonstrates that the SPE exhibits a high storage modulus at high frequencies. At a compression frequency of 1 Hz, the storage modulus is approximately 0.55 GPa, whereas at a compression frequency of 100 Hz, the storage modulus increases to approximately 0.8 GPa.

At higher LATP contents (e.g., 15% and 20%), the ionic conductivity may be decreased due to particle aggregation, which hinders ion transport pathways, and the mechanical strength will also decline.

### Example 4

### Thermal Stability of the Solid Polymer Electrolyte

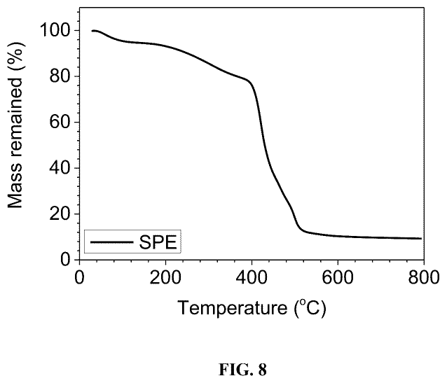

As shown in FIG. 8, the mass loss profile indicates that the SPE exhibits excellent thermal stability, with no significant degradation observed up to approximately 200° C. A gradual mass loss begins between 200° C. and 400° C., which can be attributed to the decomposition of polymeric components or residual unreacted monomers. Beyond 400° C., a rapid decline in mass is observed, suggesting the complete thermal decomposition of the polymer framework. By 600° C., the residual mass stabilizes, indicating the remaining inorganic or carbonized components. The results demonstrate that the SPE is thermally stable within the temperature range suitable for most solid-state battery applications.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

### Definition

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (m) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “crystalline polymer” refers to the materials where the polymer chains are arranged in a highly ordered, repeating pattern, resulting in a well-defined, regular structure. This ordered arrangement allows the polymer to exhibit specific properties such as high mechanical strength, better thermal stability, and a higher melting point. The crystalline regions of the polymer are tightly packed, which enhances its overall rigidity and resistance to deformation. However, the presence of crystalline regions can limit the polymer's ability to absorb moisture and increase its brittleness.

The term “non-crystalline polymer” also known as amorphous polymers, lack the regular, ordered structure seen in crystalline polymers. Instead, their polymer chains are arranged randomly or in a disordered manner. This lack of order results in more flexibility, lower melting points, and higher impact resistance. Non-crystalline polymers typically have better optical clarity and are more resistant to stress cracking than crystalline polymers. However, they can be more susceptible to degradation from UV light or high temperatures.

The term “physical abuse” in this context refers to the application of external force or impact that might typically damage or compromise the integrity of a device or component. In the given statement, it means that the pouch cell continued to function properly even when subjected to physical impacts or other forms of external physical stress.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. A flexible and liquid-free solid polymer electrolyte, comprising:
a solid polymer matrix formed from a mixture of crystalline and non-crystalline polymers, wherein the mixture has a dielectric coefficient of at least 30 at room temperature and 100 Hz, and wherein the solid polymer matrix promotes dissociation of the at least one lithium salt to free lithium ions;
at least one lithium salt; and
one or more active ceramic particles capable of conducting the lithium ions,
wherein the flexible and liquid-free solid polymer electrolyte exhibits an ionic conductivity of at least 1 mS/cm at room temperature and demonstrates a mechanical strength of at least 1 MPa.

2. The flexible and liquid-free solid polymer electrolyte of claim 1, wherein the mixture of crystalline and non-crystalline polymers is selected from the group consisting of: P(VDF-CTFE), P(VDF-CDFE), P(VDF-CFE), P(VDF-HFP), P(VDF-CDFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE).

3. The flexible and liquid-free solid polymer electrolyte of claim 2, wherein the mixture of crystalline and non-crystalline polymers is P(VDF-TrFE-CTFE), with a formula of: 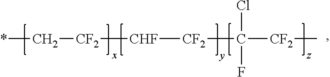
wherein x ranges from 60 to 70, y ranges from 25 to 35, and z ranges from 3 to 8.

4. The flexible and liquid-free solid polymer electrolyte of claim 3, wherein the solid polymer matrix comprises 60% to 70% of VDF, 25% to 35% of TrFE and 3% to 8% of CTFE.

5. The flexible and liquid-free solid polymer electrolyte of claim 1, wherein the solid polymer matrix has a molecular weight in a range of 40,000 to 600,000 g/mol.

6. The flexible and liquid-free solid polymer electrolyte of claim 1, wherein the at least one lithium salt comprises lithium bis(trifluoromethanesulfonyl)imide, lithium bis(fluorosulfonyl)imide, lithium perchlorate, lithium hexafluorophosphate, lithium triflate, lithium tetrafluoroborate, lithium hexafluoroarsenate, lithium bis(oxalato)-borate, lithium difluoro(oxalato)borate, or a combination thereof.

7. The flexible and liquid-free solid polymer electrolyte of claim 1, wherein the one or more active ceramic particles have a formula of Li₁₊ₓAlₓTi₂₋ₓ(PO₄)₃, x=0.2 to 0.4.

8. A method for fabricating the flexible and liquid-free solid polymer electrolyte of claim 1, comprising:
mixing the solid polymer matrix and the at least one lithium salt in an organic solvent to obtain a first homogenous solution;
adding the one or more active ceramic particles into the first homogenous solution, and mixing uniformly to obtain a second homogenous solution;
casting the second homogenous solution on a substrate; and
vacuum drying the cast substrate to obtain the flexible and liquid-free solid polymer electrolyte.

9. The method of claim 8, wherein the mass ratio of the solid polymer to the at least one lithium salt is 3:1 to 3:5.

10. The method of claim 8, wherein the mass ratio of the solid polymer to the active ceramic particles is 10:0.5 to 10:4.

11. The method of claim 8, wherein the mass ratio of the solid polymer to the organic solvent is 5:95 to 15:85.

12. The method of claim 8, wherein the organic solvent comprises N,N-dimethylformamide, acetonitrile, dimethylsulfoxide, N-methylpyrrolidone, or tetrahydrofuran.

13. The method of claim 8, wherein the vacuum drying temperature is 40-90° C. for 6-48 hours.

14. A non-flammable and impactable lithium-ion battery, comprising:
at least one negative electrode with one or more first layers;
at least one positive electrode with one or more second layers; and
a flexible and liquid-free solid polymer electrolyte of claim 1 to isolate the at least one negative electrode and the at least one positive electrode,
wherein the non-flammable and impactable lithium-ion battery is able to run for at least 20 cycles while maintaining a capacity of at least 80% or more.

15. The non-flammable and impactable lithium-ion battery of claim 14, wherein the non-flammable and impactable lithium-ion battery is designed to a lithium ion pouch cell, a coin cell, a stacking pouch cell, a wearable pouch cell, or a winding-type cell.

16. The non-flammable and impactable lithium-ion battery of claim 14, wherein the one or more first layers comprise graphite, lithium metal, carbon black, carbon nanotubes and/or graphene, or a combination thereof.

17. The non-flammable and impactable lithium-ion battery of claim 14, wherein the one or more second layers comprise lithium manganese oxide, lithium cobalt oxide and/or lithium iron phosphate, or a combination thereof.

18. The non-flammable and impactable lithium-ion battery of claim 14, wherein the non-flammable and impactable lithium-ion battery is capable of operating normally under challenging environmental conditions.

19. The non-flammable and impactable lithium-ion battery of claim 14, wherein the non-flammable and impactable lithium-ion battery further comprises a package material.

20. The non-flammable and impactable lithium-ion battery of claim 19, wherein the package material comprises an aluminum laminate of polyethylene terephthalate (PET), polyamide (PA) or cast polypropylene (CPP).
